(19) United States
(12) Patent Application Publication
(10) Pub. No.: US 2009/0050673 A1
(43) Pub. Date: Feb. 26, 2009

(54) Soldering Apparatus and Solder Tip

(76) Inventors: Charles Peter Althoff, Cleveland Hts., OH (US); E. Scott Emerson, Shaker Hts., OH (US); Jeffrey M. Kalman, Cleveland Heights, OH (US); John R. Nottingham, Bratenahl, OH (US); Renard J. Passerell, Medina, OH (US); Clifford M. Prosek, Strongsville, OH (US); William Eugene Rabbitt, Solon, OH (US); J. Evan Spirk, Gates Mills, OH (US); John W. Spirk, Gates Mills, OH (US)

Correspondence Address: JEANNE E. LONGMUIR, 2836 CORYDON ROAD, CLEVELAND HEIGHTS, OH, 44118, US

(21) Appl. No.: 12/127,810

(22) Filed: May 27, 2008

Related U.S. Application Data
(60) Provisional application No. 60/988,437, filed on Nov. 16, 2007.
(60) Provisional application No. 60/940,034, filed on May 24, 2007.

(51) Int. Cl. B23K 3/02; B23K 3/06

(52) U.S. Cl. 228/11; 228/55; 228/52; 228/9

(57) ABSTRACT

The present application discloses a fixture-free, hands-free soldering apparatus having a base support assembly and a solder assembly. The base support assembly has a base member supporting a power supply and an electronic temperature, time and speed control system, and an actuator for remotely actuating the solder assembly without the use of the operator's hands or fixtures. The solder assembly is supported on the base member by vertically movable support arms. A main body supports a spool of solder, a solder feed mechanism operated by the actuator and a solder mechanism having adjustable operating temperature, speed and position. The main body and adjustable solder mechanism of the solder assembly adjust the angle and position of the solder being fed by the solder feed mechanism and an adjustable solder head supporting a concave solder tip. In addition to vertical movement, the main body is rotatable by about 60 degrees with respect to a central horizontal plane along the main body. The adjustable solder head of the solder assembly is also rotatable by over 100 degrees with respect to a central vertical plane along the main body. A pressure or motion sensor positioned on the adjustable soldering mechanism may be used to signal the contact to the mechanism by work pieces, and delays solder from being fed by the solder feed mechanism, until the desired time has elapsed for the pieces to reach a minimum desired temperature. A fume removal system removes soldering fumes from the work area during operation of the solder apparatus.

### CROSS-REFERENCE TO RELATED APPLICATIONS

The present application claims priority from U.S. Patent Application Ser. Nos. 60/940,034 filed May 24, 2007, and 60/988,437 filed Nov. 16, 2007, the entire subject matters of which are incorporated herein by reference.

### BACKGROUND OF THE INVENTION

1. Field of Invention

The present application relates to a soldering apparatus, and more particularly, to a device for variably delivering the desired precise or continuous amounts of solder from a preferred adjustable position, and which does not require the hands of the operator to apply the solder, freeing the hands for holding the components to be soldered. An improved solder tip is also disclosed for more precise application of solder to the components to be soldered.

2. Background of the Related Art

A variety of soldering devices are well known for supplying soldering material for joining multiple work pieces held by an operator. As set forth, for example, in U.S. Pat. No. 6,550,663, such inventions include devices for automated solder delivery and devices which combine a soldering iron or gun with a delivery device. It is the method for supplying the desired amount of solder, either in metered amounts or continuously, which often results in the need for expensive and/or complicated sensors to provide the desired amount of solder.

Additionally, to improve the quality of the solder joint created, the use of sensors is preferred to verify that the work pieces have been heated to the correct temperature before applying solder and a soldering iron to the work pieces. Such devices are not available to perform the necessary operations, without requiring the use of the additional fixtures for holding the work pieces and equipment.

### SUMMARY OF THE INVENTION

The present application provides a new and improved fixture-free, hands-free, automated, soldering apparatus for delivering a precise or continuous amount of solder, as may be desired by an operator, to a desired location, which location may be adjusted by the operator prior to use. An improved solder tip may be used in connection with the present device, or other soldering iron devices. The soldering apparatus is a powered soldering apparatus having a base support assembly, supporting a fixture-free, hands-free solder assembly, which provides substantial improvement to shorten the time of soldering operations and improve the quality of the solder joint created. The elimination of fixturing greatly reduces process time. The apparatus may be supplied by either AC or DC power. The base support assembly includes an electronic control system interconnected with a foot pedal or other convenient actuator, such as a knee bar, for hands-free control of the supply of solder to the solder assembly. The electronic control system enables adjustment of both operating speed and temperature of the apparatus. The base support assembly also permits vertical movement of the hands-free solder assembly on support arms.

The fixture-free, hands-free solder assembly includes a main body supporting a spool of solder, a solder feed drive mechanism operated by the foot pedal and an adjustable solder mechanism. The present application provides for a variety of adjustment in the operating temperature as well as the angle and position of the solder mechanism. The main body and adjustable solder mechanism permit adjustment of the angle and position of the solder being fed by the solder feed mechanism and an adjustable solder head supporting an adjustable solder tip of the adjustable solder mechanism. The main body moves vertically on the support arms, and also rotates the solder feed mechanism and the adjustable solder head with respect to a central horizontal plane along the main body of the hands-free solder assembly. The adjustable solder head further rotates with respect to a central vertical plane along the main body, and the adjustable solder tip rotates with respect to the central horizontal plane of the main body, to provide the operator with a broad range of adjustability with respect to the solder head and tip position.

Additional improved control of the solder is provided by the present device, enabling improved solder joint quality. One typical problem with poor soldering joint quality is the “cold solder joint.” If the joint, or the work piece components to be joined, is not heated properly or to the desired temperature, solder will flow into the joint between the work piece components, but may not bond to the metal, and eventually the joint can crack and break. Workers are typically trained to heat the joint with the hot soldering iron tip before applying the solder. Prior art pre-heating techniques rely on human judgment, so of course mistakes are made. Pressure for speed during the manufacturing process also works against taking the proper time to heat the joint formed by the work piece components. One alternative embodiment in the improved device of the present application provides for heating of the work pieces and makes use of a thermocouple clipped to the part(s). For example, a thermocouple device is clipped to one (or both) work piece components, and the soldering iron tip is held against the work piece components. When the work piece components reach the desired critical temperature, the thermocouple activates the foot petal or other actuating device to advance the solder (or the solder advances directly). The solder is prevented from moving, or has a brake on it, until the parts reach the critical temperature.

A second alternative to improve product quality and avoid the cold solder joint problem, involves the use of a brake on the wire advance. A pressure sensor is provided in the soldering iron tip, and signals when there is contact on the tip against the work piece components. After an appropriate amount of from the contact signal, the brake on the solder advance is released. When the pedal is depressed, the solder is permitted to advance. The time delay between the signaled pressure contact and the release of the brake is adjustable to the desired length of time. The time delay ensures that the work piece components forming the joint are heated to the desired critical temperature, removing operator error from the process, and improving product quality.

Another improvement to the quality of the joint is obtained using the improved solder tip. In the improved solder tip of the present application, the tip has a grooved out or cup shaped portion or indent, to form a concave shaped tip. The use of the concave tip enables better solder control by avoiding deflection of the solder when it engages the typical cylindrical tip. The groove or indent enables the solder to move into the tip without deflecting, so that better control and direction of the liquid solder exiting the hot solder tip is provided.

An exhaust fan is also provided within the main body of the adjustable soldering mechanism. The use of an exhaust fan enables removal of gas or fumes generated during the heating of certain solders and fluxes, which, if not removed, would otherwise be inhaled by the operator. It is to be understood that the specific devices and processes illustrated in the attached drawings, and described in the following specification are simply exemplary embodiments of the inventive concepts. Hence, specific examples and characteristics relating to the embodiments disclosed herein are not to be considered as limiting.

### BRIEF DESCRIPTION OF DRAWINGS

The present disclosure of the embodiments of the invention and its mode of operation, will be better understood from the following drawings:

FIG. 1 is a perspective view of the improved soldering apparatus and remote actuator or foot pedal of the present application;

FIG. 2 is a rear partial perspective view of the soldering apparatus of FIG. 1 with the lid enclosing the spool of solder removed;

FIG. 3 is a partial, enlarged top view of the soldering apparatus of FIG. 2;

FIG. 4 is a partial, enlarged view of the solder tip assembly of the soldering apparatus of FIG. 1;

FIG. 5 is a perspective view of the improved soldering apparatus of the present application;

FIG. 6 is an end view of the improved soldering apparatus of the present application;

FIG. 7 is a perspective view of the improved soldering apparatus of FIG. 1 with the solder tip assembly shown in an adjusted position;

FIG. 8 is a perspective view of the improved soldering apparatus of FIG. 1, with the solder tip assembly shown in another adjusted position;

FIG. 9 is a partial, end view of the improved soldering apparatus of FIG. 1;

FIG. 10 is a partial, top view of the control system operator controls of the improved soldering apparatus of FIG. 1;

FIG. 11 is a partial, side view of the tip assembly of the improved soldering apparatus of FIG. 1;

FIG. 12 is a partial, enlarged view of the tip assembly of FIG. 11;

FIG. 13 is a bottom view of the improved soldering apparatus of FIG. 1;

FIG. 14 is a partial view of the storage compartment in the base member of the support assembly of the improved soldering apparatus of FIG. 1;

FIGS. 15a and 15b provide a schematic illustration of the vertical movement of the main body on the support arms of the improved soldering apparatus of the present application;

FIGS. 16a and 16b provide a schematic illustration of the range of horizontal adjustment of the main body on the support arms of the improved soldering apparatus of the present application;

FIGS. 17a and 17b provide a schematic illustration of the range of rotational adjustment of the main body on the support arms of the improved soldering apparatus of the present application;

FIG. 18 is a cross-sectional view taken along the line A-A of FIG. 6;

FIG. 19 is a cross-sectional view taken along the line B-B of FIG. 5;

FIG. 20 is a partial exploded view of the improved soldering apparatus of the present application;

FIG. 21a, 21b and 21c are right side, left side and top views, respectively, of the improved solder tip with a concave section;

FIG. 22 is an electrical circuit schematic diagram of the automatic, powered improved soldering apparatus of the present application;

FIGS. 23a and 23b are partial, schematic illustrations of tip cleaning devices for the improved soldering apparatus of the present application;

FIG. 24 is a schematic illustration of an alternate embodiment for obtaining adjustability in the position of the solder tip assembly in the improved soldering apparatus of the present application;

FIG. 25 is a schematic illustration of another alternate embodiment for obtaining adjustability in the position of the solder tip assembly in the improved soldering apparatus of the present application;

FIG. 26 is a schematic illustration of yet another alternate embodiment for obtaining adjustability in the position of the solder tip assembly in the improved soldering apparatus of the present application; and

FIG. 27 is a schematic illustration of still another alternate embodiment for obtaining adjustability in the position of the solder tip assembly in the improved soldering apparatus of the present application.

### DETAILED DESCRIPTION OF THE PREFERRED EMBODIMENTS

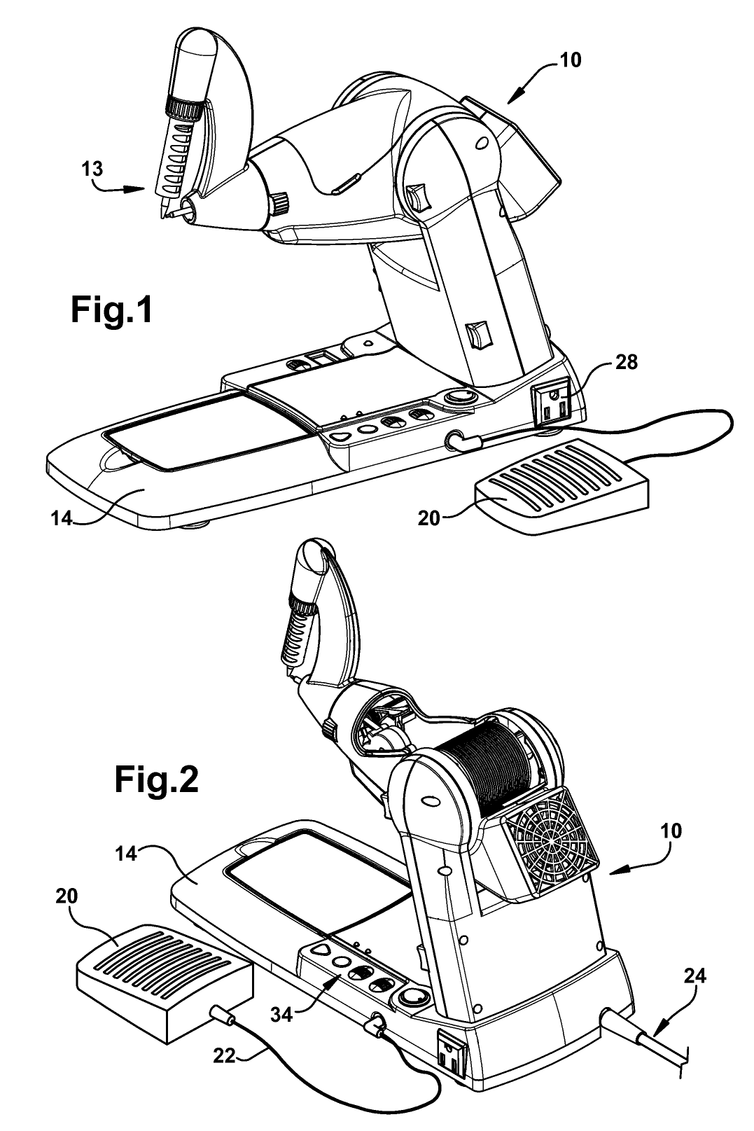

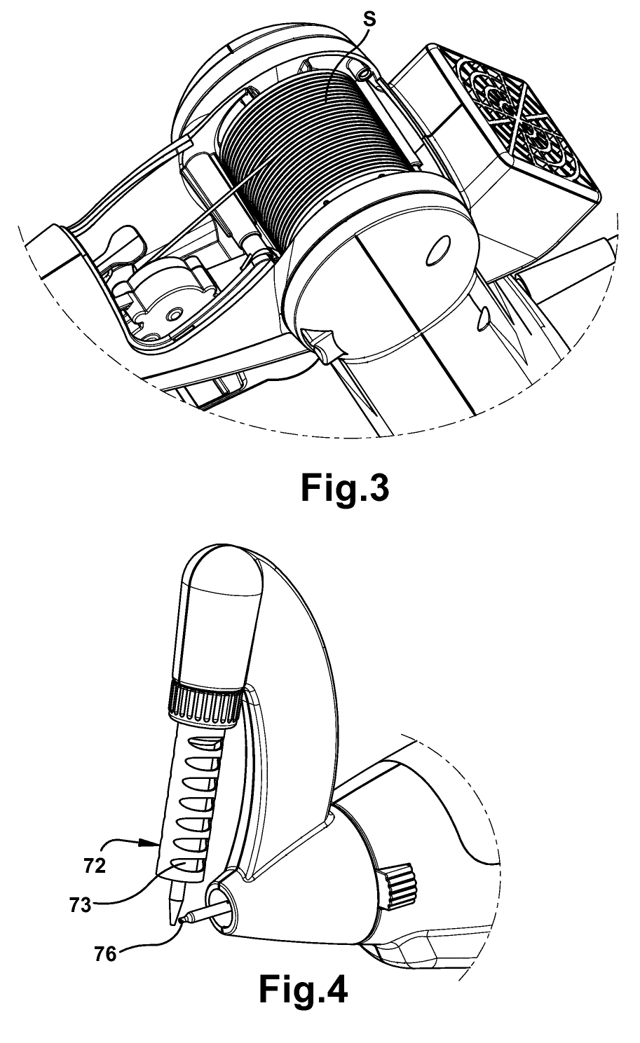

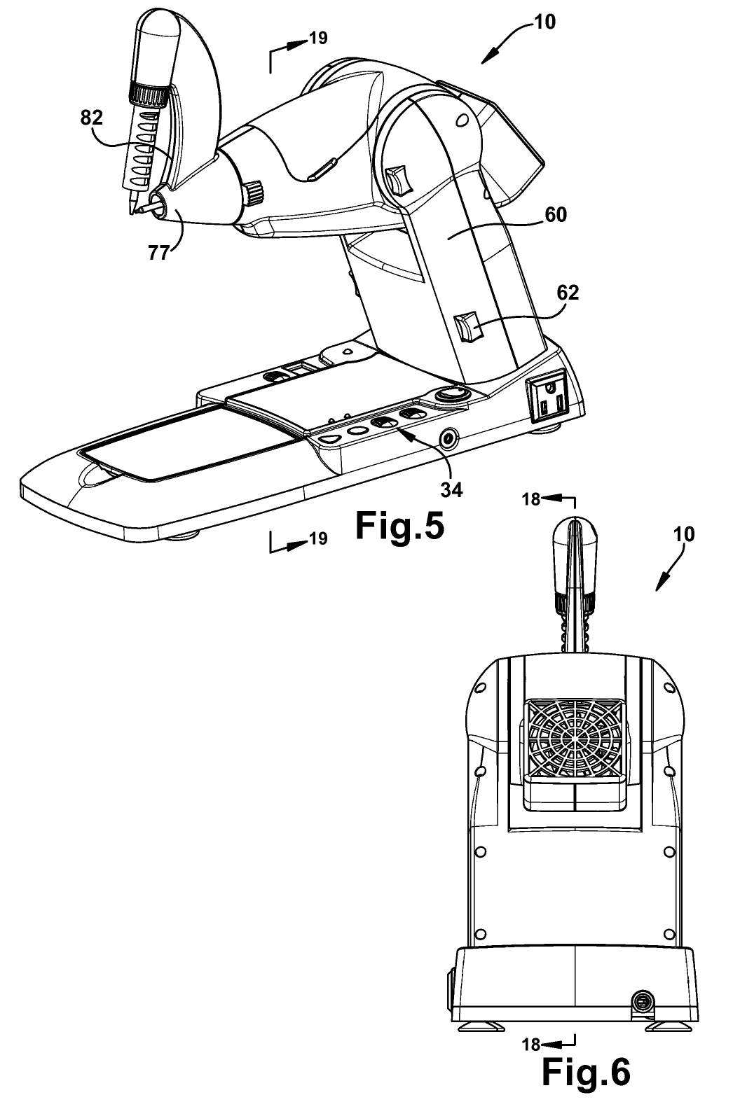

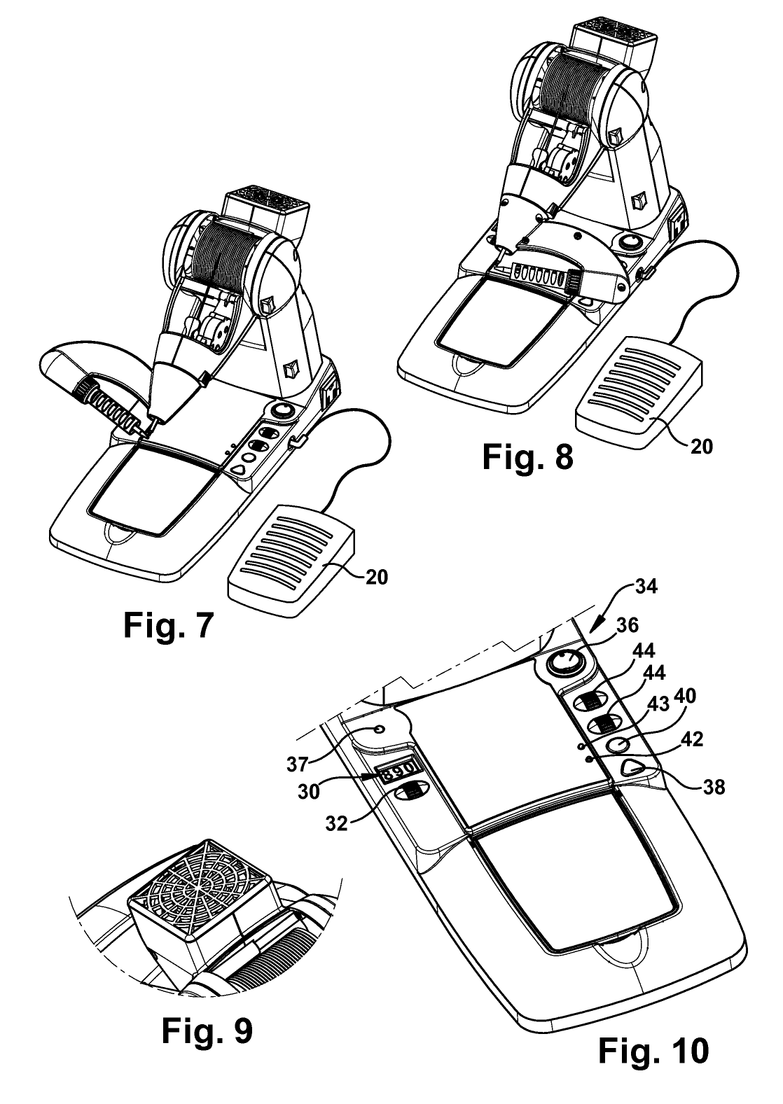

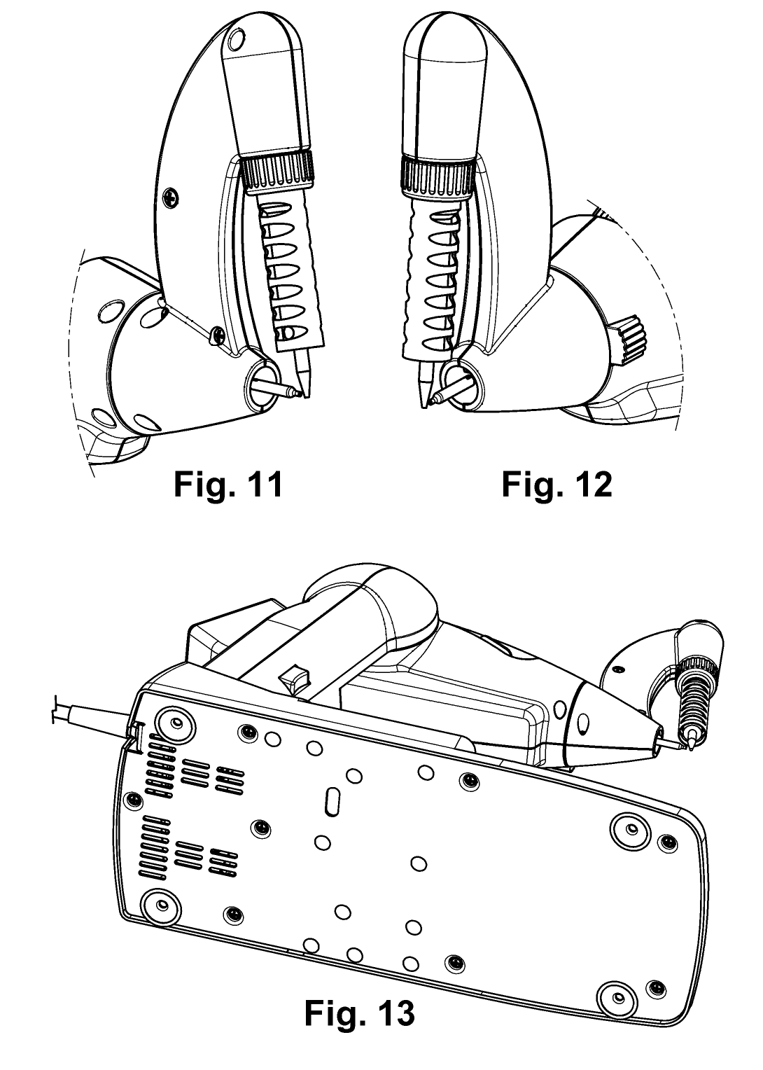

The improved powered soldering apparatus 10 of the present application includes a base support assembly 12 and a hands-free, fixture-free solder assembly 13. The base support assembly 12 includes a base member 14 supporting a control system 16 having an interconnected operating foot pedal or actuator 20 for controlling the feed of solder to the solder assembly. A flexible, elongate cable 22 provides the interconnection. The apparatus may be supplied by AC electrical power, as in the illustrated embodiment of a detachable power cord, for use in a conventional wall socket. A transformer is provided which reduces the 110V AC inlet voltage to a 12V AC output and a 24V AC outlet. In the illustrated embodiment of FIGS. 1-8, a 110V outlet 28 is also provided for an extra plug for convenience so that the user can plug in another device. A light 82 is positioned to illuminate the tip area during operation of the apparatus 10.

The base support assembly further includes an electronic circuit board 18 to embody the control system 16 for the apparatus 10. The control system 16 and circuit board 18 regulate operator adjustment of temperature control, via potentiometers 32, which temperature setting is provided by the digital display 30 illustrated on the base support. Additionally, the control system 16 includes the following operator controls 34 on the base support assembly 12: a power or on/off control button (with a colored LED to indicate the on or off condition of the apparatus) 36; a reverse direction control button 38, a continuous/discrete or metered supply control button 40, so that the operator may select that solder be supplied either continuously or in a desired metered amount, and additional colored LED's to illustrate operation of the apparatus in either continuous (red LED) 42 or discrete (yellow LED) 43 mode. Additional potentiometers, shown as dial controls 44 on the base member 14, are also provided to control the speed of delivery of the solder in either mode, as well as in the reverse mode. Interconnected with the control system is a foot pedal or actuator 20 (which may also be a knee bar), shown as a spring biased actuator, which enables fixture-free, hands-free operation of the apparatus 10 at the desired operator settings.

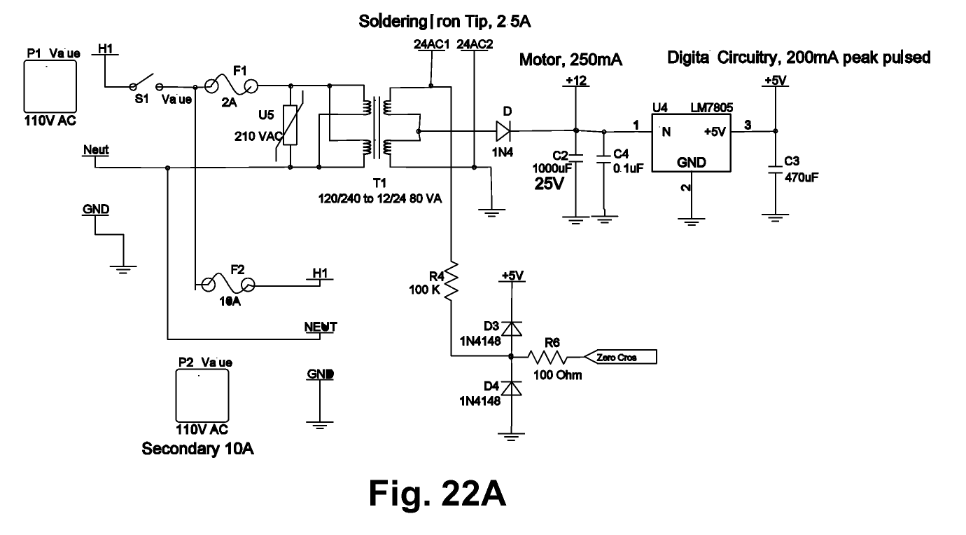

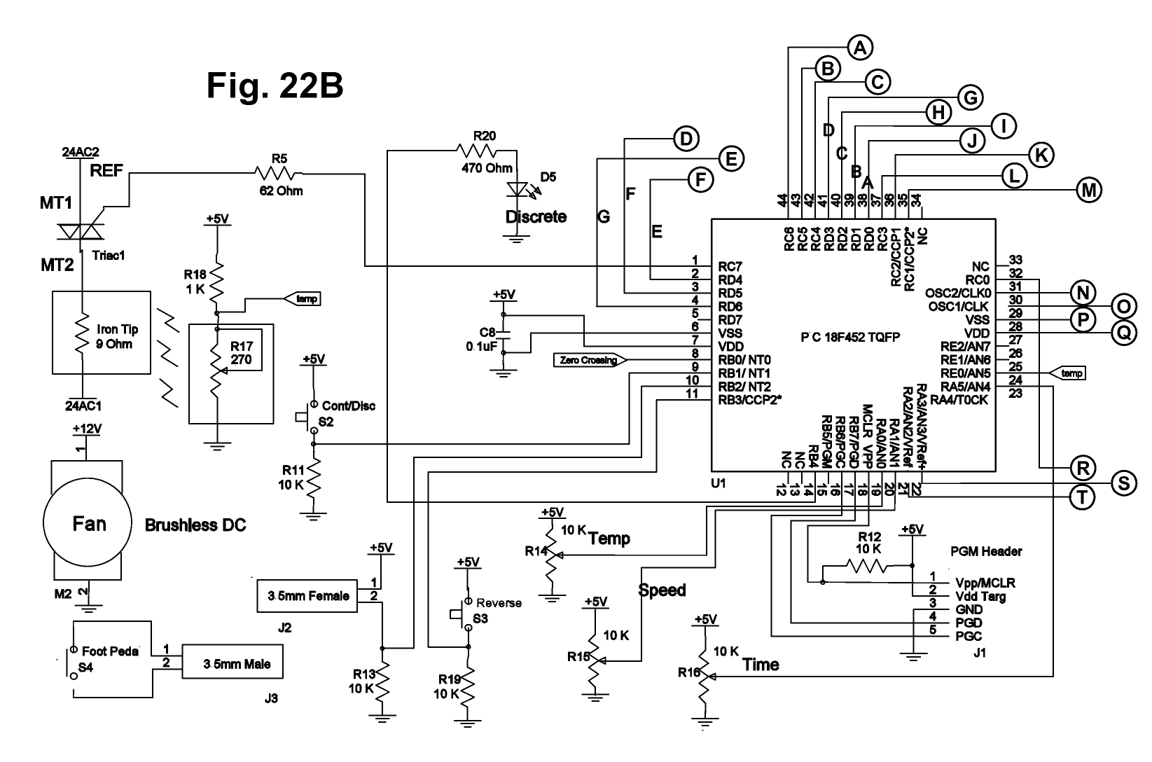

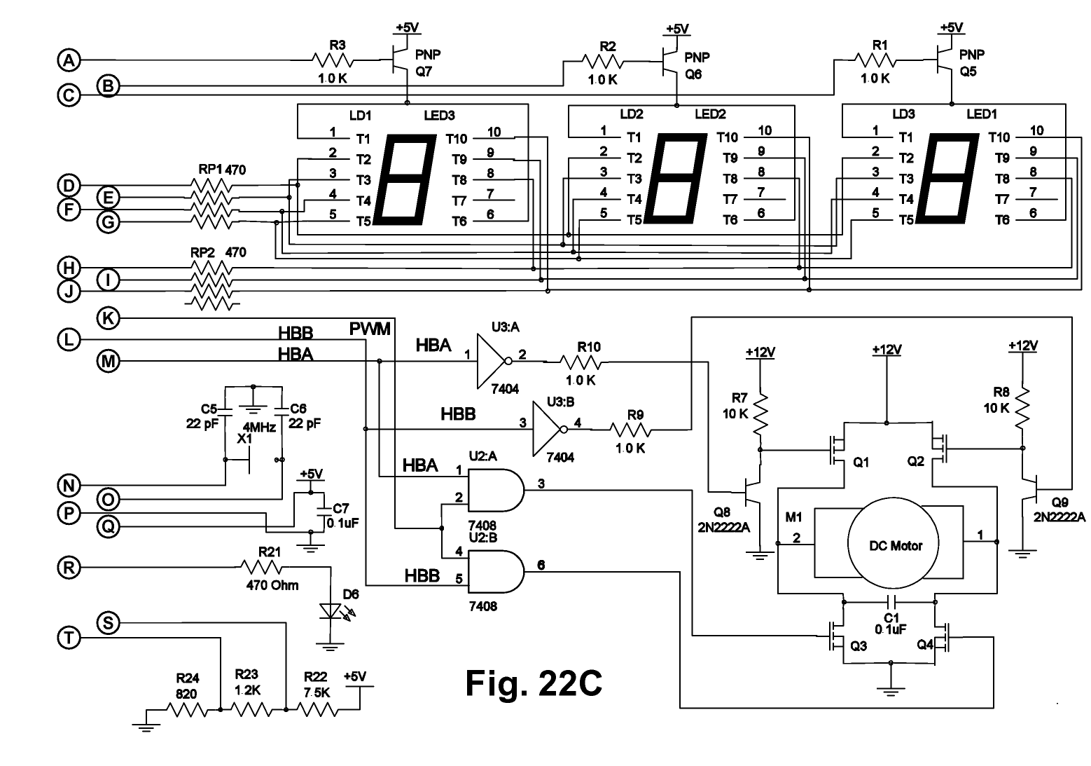

FIG. 22 schematically presents the electrical circuitry of an embodiment of the control system 16, which may be found in the electronic circuit board 18 of the improved soldering apparatus.

Once the desired speed, temperature and time or span, settings have been determined, a “lock down” position of the device is also provided to maintain the settings in their desired positions. Such a “lock-down” setting is generally used in a manufacturing setting by a supervisor to ensure operator compliance with the manufacturing conditions established. The settings may be provided by: a USB memory stick 81 inserted into the base member at the opening 80 to download settings, where the settings are not provided on the electronic circuit board 18 of the system. A supervisor key fob 81 with the pre-programmed settings may also be inserted into the device, to activate controls on the circuit board 18. Keycards may alternatively be provided for individual solder job settings, which would not be contained on the circuit board 18.

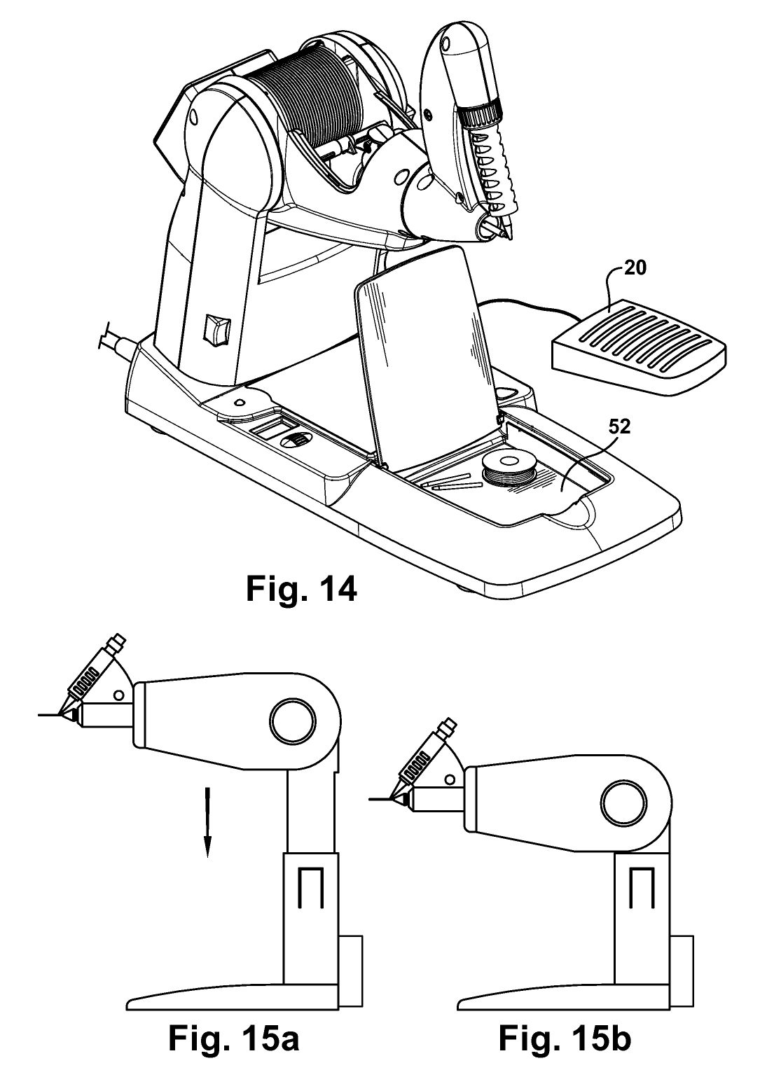

The base support assembly 12 further includes a base member 14, having a drip pan 46 for holding molten waste solder, a clamp or other attachments may be used to secure the apparatus 10 to a work table, a storage compartment 50 for soldering tip cleaner 52, different sized, shaped or extra tips and extra solder, etc. Suction feet 45 are used to secure the base member to the working surface in the illustrated embodiment. Optional forms of such accessories are shown in FIGS. 14 and 23a, 23b, and may also include different shaped soldering tips for use in the apparatus, such as chisel, conical, screwdriver and diamond.

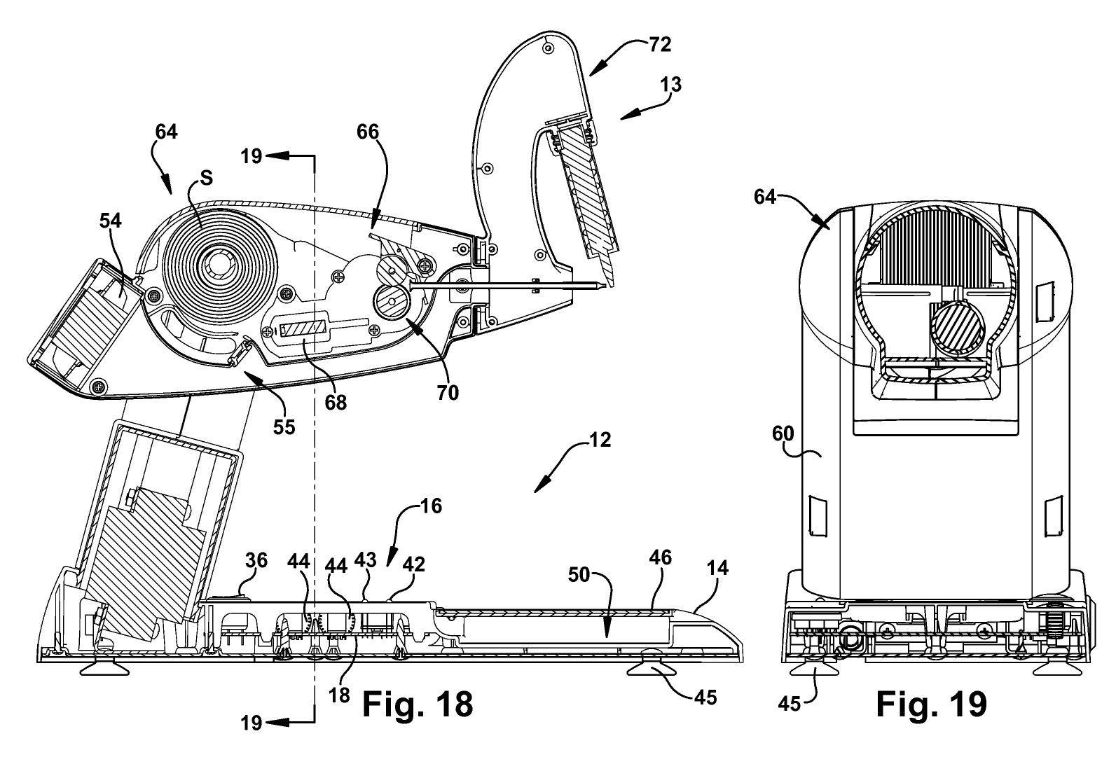

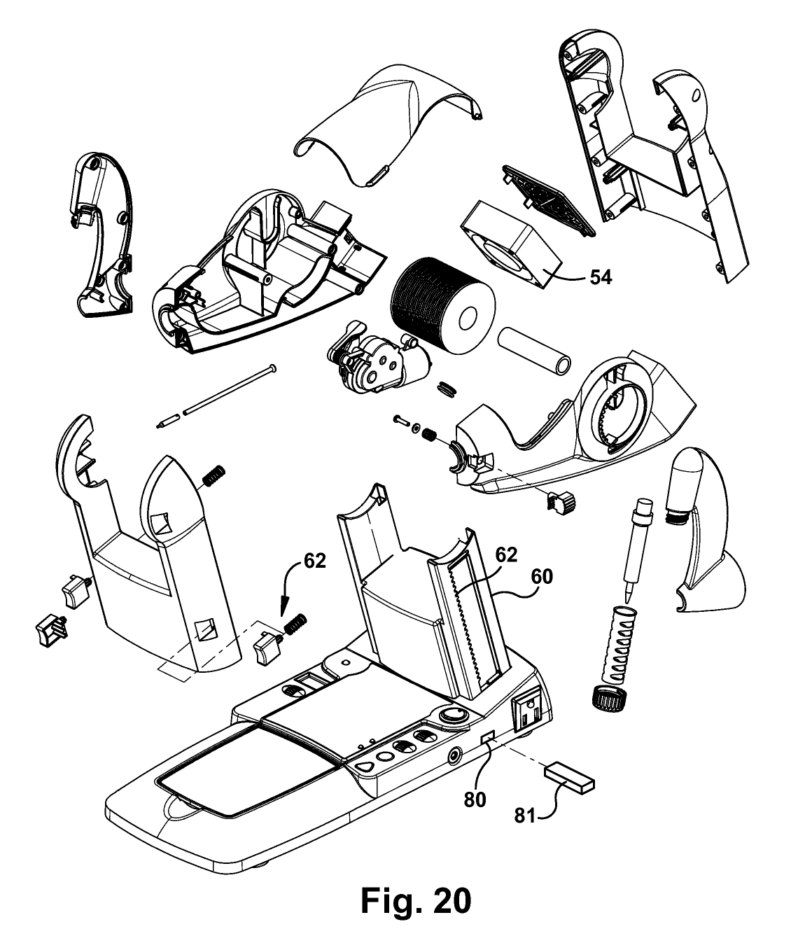

Still further, an auto-turn off feature is also provided, whereby the apparatus shuts off after 15 minutes of the solder feed mechanism being idle. Counters may also be provided to keep track of the inches of solder used, or how many part joints are completed. A fan 54 is also mounted, interconnected with an air plenum 55 within the main body within the apparatus, as best shown in FIGS. 9, 18 and 20, and is mounted to draw soldering fumes through or over the unit. In one of the illustrated embodiments, the fan 54 draws fumes through the unit and out the top of the unit, where they enter an exhaust removal system for treatment. Additional work lights and magnifying glasses may also be added.

The base support assembly permits vertical movement of the hands-free solder assembly on support arms 60, extending from the base member 14. The illustrated spring biased locking members 62 engaged within grooved slots within the support arms 60 enable vertical movement, by at least 3-4 inches, of the support arms 60 from the base member. Supported on the support arms is a main body 64 of the hands-free solder assembly 13. The main body supports a spool of solder S, a solder feed mechanism 66 operated by the foot pedal 20 and the adjustable solder mechanism or soldering iron 72. The solder feed mechanism 66 includes a conventional motor 68 and interconnected gear drive mechanism 70 to feed a supply of solder to the solder head 74, which includes a heating element 73, and solder tip 76 of the solder mechanism as shown. The main body 64 and adjustable solder mechanism 72 together enable adjustment of the angle and position of the solder being fed by the solder feed mechanism 66, and an adjustable solder head 74 supporting an adjustable solder tip 76 of the solder mechanism provide further angles of adjustment.

While the main body 64 moves vertically on the support arms 60, it also rotates the solder feed mechanism 66 and the adjustable solder head 74 with respect to a central horizontal plane CHP along the main body 64 of the fixture-free, hands-free solder assembly 13. The adjustable solder head 74 further rotates with respect to a central vertical plane CVP along the main body of the fixture-free, hands-free solder assembly 13, and the adjustable solder tip 76 rotates with respect to the central horizontal plane CHP of the main body.

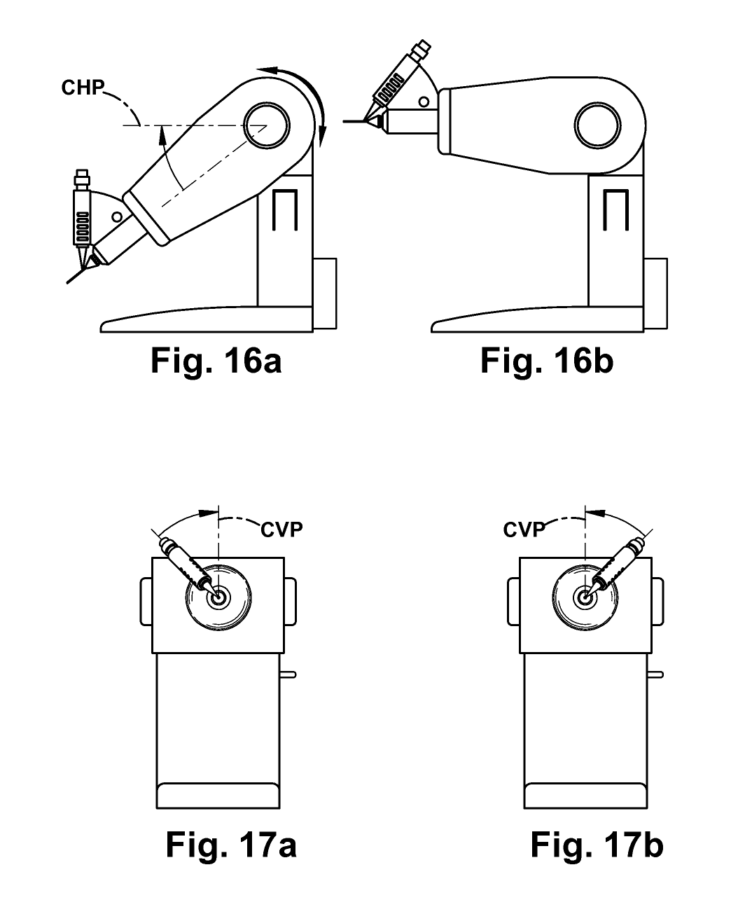

The hands-free solder assembly main body 64 supports a spool of solder S, a solder feed drive mechanism 66 operated by the foot pedal 20 and an adjustable solder mechanism 72. The present application provides for a variety of adjustment in the operating temperature as well as the span, or time, of feed, solder speed, solder direction (forward or reverse), and the angle and position of the solder mechanism as shown in FIGS. 15a to 17b.

The main body 64 and adjustable solder mechanism 72 permit adjustment of the angle and position of the solder being fed by the solder feed mechanism 66 and an adjustable solder head 74 supporting an adjustable solder tip 76 of the solder mechanism. The main body moves vertically on the support arms 60, and also rotates the solder feed mechanism 66 and the adjustable solder head 74 with respect to a central horizontal plane along the main body 64 of the hands-free solder assembly 13. The adjustable solder head further rotates with respect to a central vertical plane CVP along the main body, and the adjustable solder tip rotates with respect to the central horizontal plane of the main body 64, to provide the operator with a broad range of adjustability with respect to the solder head and tip position.

The present apparatus provides the operator with a great deal of adjustment so that the operator is comfortable, can see the work pieces, in order to create a good solder joint. Depending on what the operator is soldering, certain angles of attack will work better then others, and gravity also plays a role. While the angles could be changed, the present application provides an example of the general nature of the angles which could be provided.

Additionally, in order to ensure a high quality solder joint is created, a cold solder joint sensor may be provided in the form of a tip sensor 77. When the heating element 73 in the soldering iron 72 is on, and the tip 76 is engaged with the parts to be soldered, the sensor 77 detects pressure or motion or temperature (thermocouple, for example), depending on the type of sensor used, before initiating the solder feed. The sensor signals the feed mechanism to delay before solder is dispensed until the desired temperature is attained within the work pieces, or motion or pressure engagement with the work pieces is determined, by waiting for the desired time prior to dispensing. The setting for the time delay after temperature, pressure or motion is sensed, until solder is fed, is a supervisor adjustable parameter.

In the current apparatus, components may be manufactured of high temperature polymer, for example, ABS polymer, where they are needed adjacent components which are heated, or metal materials.

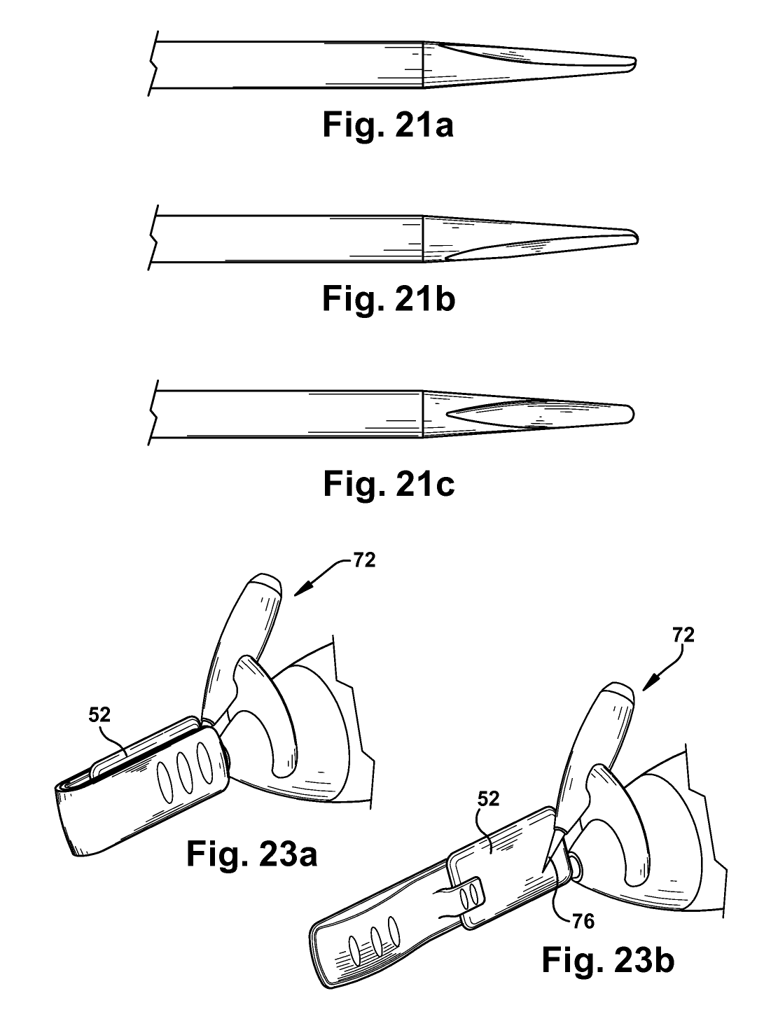

The present application also provides an improved solder tip 76. The improved concave solder tip illustrated in FIGS. 21a to 21c, helps to catch and direct solder fed from the unit. In an alternate embodiment, the solder tip 76 may be used with a keyed end to lock into the heating element in order to provide a still further improvement. As illustrated, the tip 76 has a grooved out or cup shaped portion 78 or indent to form the concave tip. The use of the concave tip 78 enables better solder control, which in turn results in the manufacture of a better quality solder joint. Typically solder deflects when it engages the tip but the indent enables the solder to move into the tip without deflecting, and movement into the tip provides continued control and direction of the liquid solder.

A still further improvement for use in the present soldering apparatus is a solder tip cleaner 52. As shown schematically in FIGS. 23a and 23b, a manual sponge may be provided, or alternatively, a mounting mechanism for the sponge may be provided which is either a non-powered mounting mechanism, or a powered mechanism which would provide movement of the sponge with respect to the solder tip 76. Such a powered mechanism may include a solenoid-actuator sponge which is mounted under the solder tip, or may be foot pedal 20 actuated. Still further, adjustable settings for using the powered mechanism for cleaning at a set frequency or timing, and in a semi-automatic mode may also be provided.

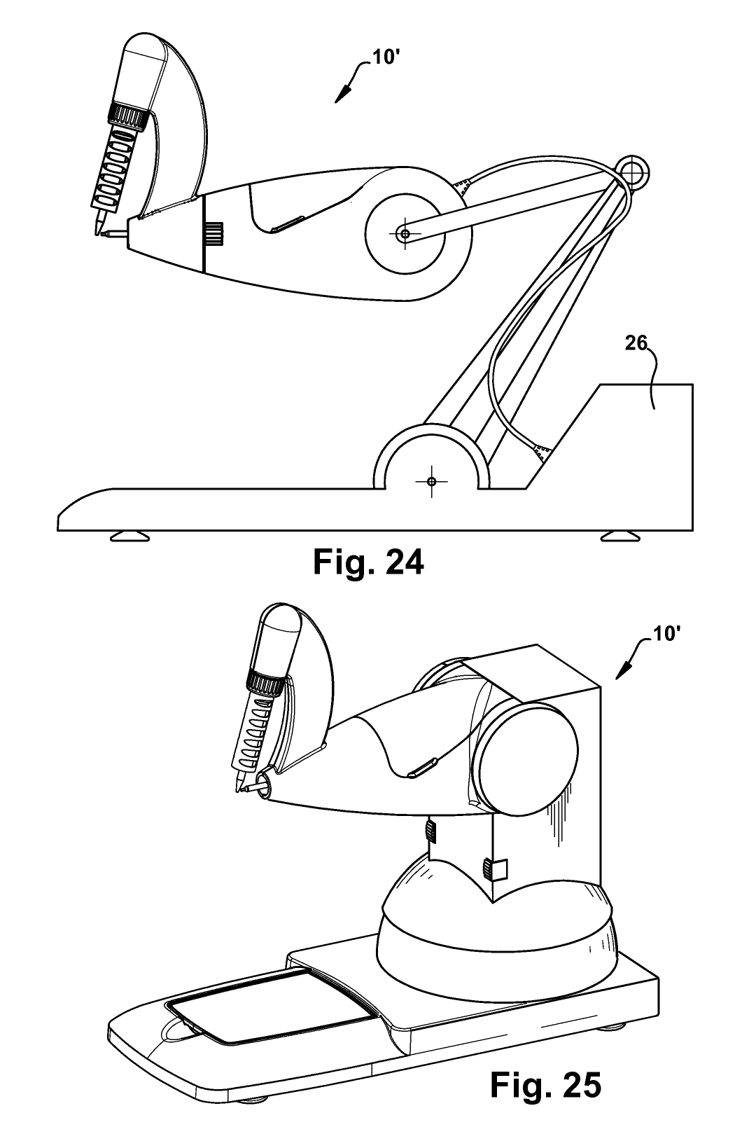

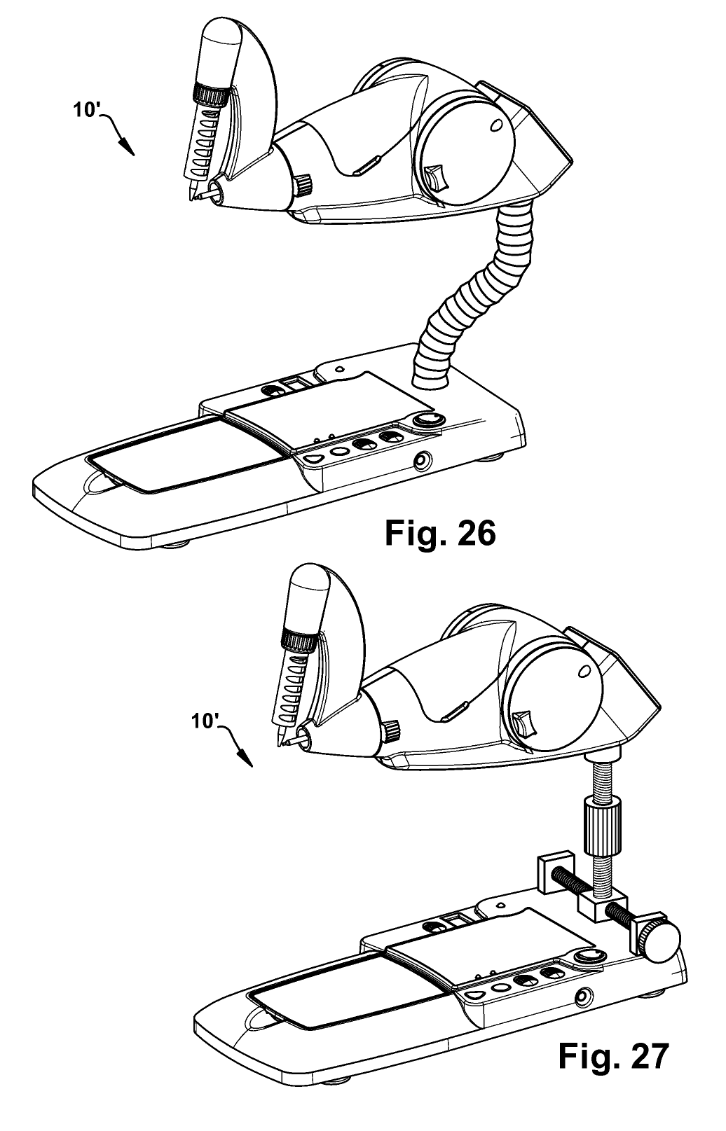

Alternate applications for achieving the adjustability of the soldering apparatus 10 are shown using the prime designation. In FIG. 24, numerous locking pivot axes are provided. In FIG. 25, a swivel or spherical joint is used at the base member. In FIG. 26, adjustability is obtained using flexible joints with friction locks. While in FIG. 27, vertical and horizontal adjustable lead screws are used to provide the desired adjustability.

The description of the present invention has been presented for purposes of illustration and description, and is not intended to be exhaustive or limited to the invention in the form disclosed. Many modifications and variations will be apparent to those of skill in the art. Although the depicted illustrations show the mechanism of the present invention in various embodiments, these embodiments were chosen, described and illustrated to best explain the principles of the invention, the practical application, and to enable others of ordinary skill in the art to understand the invention for various embodiments with various modifications as are suited to the particular use contemplated.

We claim:

1. A solder apparatus comprising: a base support assembly and a solder assembly;
the base support assembly includes a base member supporting a power supply and an electronic temperature and speed control system having an operating actuator for remotely actuating the solder assembly without the use of the operator's hands or fixtures,
the solder assembly is supported on the base member by vertically movable support arms, and includes a main body supporting a spool of solder, a solder feed mechanism operated by the actuator and a solder mechanism having adjustable operating temperature, speed and position,
the main body and adjustable solder mechanism of the solder assembly adjust the angle and position of the solder being fed by the solder feed mechanism and an adjustable solder head supporting a solder tip of the solder mechanism,
in addition to vertical movement on the support arms, the main body is rotatable by about 60 degrees with respect to a central horizontal plane along the main body of the solder assembly,
the adjustable solder head of the solder assembly is rotatable by over 100 degrees with respect to a central vertical plane along the main body of the hands-free solder assembly.

2. A solder apparatus comprising: a base support assembly and a solder assembly;
the base support assembly includes a base member supporting a control system having an interconnected operating foot pedal,
the solder assembly is supported on the base member by vertically movable support arms, and includes a main body supporting a spool of solder, a solder feed mechanism operated by the foot pedal and a solder mechanism adjustable in both operating temperature and position,
the main body and adjustable solder mechanism of the solder assembly adjust the angle and position of the solder being fed by the solder feed mechanism and an adjustable solder head supporting an adjustable solder tip of the solder mechanism,
the main body moves vertically on the support arms, and rotates solder feed mechanism and adjustable solder head with respect to a central horizontal plane along the main body of the hands-free solder assembly,
the adjustable solder head further rotates with respect to a central vertical plane along the main body of the solder assembly, and the adjustable solder tip rotates with respect to the central horizontal plane of the main body.

3. A solder apparatus comprising: a base support assembly and a hands-free solder assembly;
the base support assembly includes a base member supporting a control system having an interconnected operating foot pedal for positioning the foot pedal remotely from the hands-free solder assembly,
the solder assembly is supported on the base member and includes a main body supporting a spool of solder, and a solder feed mechanism operated by the foot pedal to provide solder to a solder mechanism either continuously or in discrete increments; and
the main body and adjustable solder mechanism of the solder assembly are movable so that the solder being fed by the solder feed mechanism to the adjustable solder mechanism are provided to a predetermined desired location.

4. A solder tip having an attachment portion and a solder tip portion, the solder tip portion having a concave section to catch and more accurately direct liquid solder away from the solder tip portion.

5. A soldering apparatus having a fume removal system for removing soldering fumes from the work area during operation of the solder apparatus toward the back of the apparatus and away from the operator.

6. The solder apparatus of claim 5 further having an interconnection to an external environmental exhaust system for fume removal and treatment.

7. The solder apparatus of claims 1, 2 or 3, having a fume removal system for removing soldering fumes from the work area during operation of the solder apparatus.

8. The solder apparatus of claims 1, 2, 3 or 5 having a pressure or motion sensor positioned on the adjustable soldering mechanism which signals the application of the work pieces to the soldering mechanism, and delays solder from being fed by the solder feed mechanism until the desired time has elapsed.

9. The solder apparatus of claims 1, 2, 3 or 5 having a temperature sensor positioned on the adjustable soldering mechanism which signals the desired temperature of the work pieces has been attained, and delays solder from being fed by the solder feed mechanism until the desired temperature is reached.
